(19) United States
(12) Patent Application Publication
(10) Pub. No.: US 2025/0246707 A1
(43) Pub. Date: Jul. 31, 2025

(54) PRISMATIC SECONDARY LITHIUM-ION BATTERY CELL

(71) Applicant: GM Global Technology Operations LLC, Detroit, MI (US)

(72) Inventors: Seung-Woo Chu, Sterling Heights, MI (US); Kan Huang, Sterling Heights, MI (US); Mansu Park, Rochester Hills, MI (US)

(21) Appl. No.: 18/423,897

(22) Filed: Jan. 26, 2024

(51) Int. Cl. H01M 10/653; H01M 10/0525; H01M 10/0569; H01M 10/613; H01M 50/105; H01M 50/107

(52) U.S. Cl. CPC H01M 10/653; H01M 10/0525; H01M 10/0569; H01M 10/613; H01M 50/105; H01M 50/107; H01M 2220/20; H01M 2300/0025

(57) ABSTRACT

An electrical system includes a battery pack having a battery cell. The battery cell includes a housing having at least one side and forming a chamber, an electrode assembly disposed within the chamber, and an insulation assembly disposed in the chamber between the electrode assembly and the at least one side of the housing. The insulation assembly includes a heat absorbent material enclosed by a plastic cover. The heat absorbent material has a non-flammable liquid stored therein. The plastic cover is configured to shrink when a temperature of the plastic cover is above a threshold temperature, thereby releasing the non-flammable liquid from the heat absorbent material into the chamber to reduce a flow of heat from outside of the housing to the electrode assembly.

### INTRODUCTION

The subject disclosure relates to a battery pack for an electric vehicle and, in particular, to a battery cell of the battery pack including an insulation apparatus for inhibiting a propagation of a thermal runaway event in the battery pack.

A battery pack is used to power an electric vehicle. The battery pack includes a plurality of battery cells that operate to supply the power. An internal short circuit occurring in one battery cell can generate heat, which can cause a short circuit in an adjacent battery cell. This process can cascade out of control in an event referred to as thermal runaway event. Accordingly, it is desirable to provide a battery pack that is resistant to a thermal runaway event.

### SUMMARY

In one exemplary embodiment, a battery cell is disclosed. The battery cell includes a housing having at least one side and forming a chamber, an electrode assembly disposed within the chamber, and an insulation assembly disposed in the chamber between the electrode assembly and the at least one side of the housing. The insulation assembly includes a heat absorbent material enclosed by a plastic cover. The heat absorbent material has a non-flammable liquid stored therein. The plastic cover is configured to shrink when a temperature of the plastic cover is above a threshold temperature, thereby releasing the non-flammable liquid from the heat absorbent material into the chamber to reduce a flow of heat from outside of the housing to the electrode assembly.

In addition to one or more of the features described herein, the at least one side includes a first wall and a second wall opposite the first wall with the battery cell disposed between the first wall and the second wall and the insulation assembly includes a first insulation apparatus disposed between the electrode assembly and the first wall and a second insulation apparatus disposed between the electrode assembly and the second wall.

In addition to one or more of the features described herein, the at least one side includes a first wall and a second wall opposite the first wall with the battery cell disposed between the first wall and the second wall, wherein the insulation assembly includes an adhesive layer having a first section having a first insulation apparatus and a second section having a second insulation apparatus, wherein the adhesive layer adheres to the electrode assembly to dispose the first insulation apparatus between the first wall and the electrode assembly and the second insulation apparatus between the battery cell and the second wall.

In addition to one or more of the features described herein, the adhesive layer includes a third section between the first section and the second section, the third section adhering to a bottom of the electrode assembly.

In addition to one or more of the features described herein, the heat absorbent material is made of metal hydroxide and the non-flammable liquid is an organic solvent.

In addition to one or more of the features described herein, the housing is in the form of a cylindrical tube, the electrode assembly is in the shape of a cylindrical electrode and disposed within the cylindrical tube, and the insulation assembly is disposed between the cylindrical tube and the cylindrical electrode.

In addition to one or more of the features described herein, the housing includes a pouch film wrapped around the electrode assembly with the insulation assembly between the electrode assembly and the pouch film.

In another exemplary embodiment, battery pack for an electrical system is disclosed. The battery pack includes a battery cell. The battery cell includes a housing having at least one side and forming a chamber, an electrode assembly disposed within the chamber, and an insulation assembly disposed in the chamber between the electrode assembly and the at least one side of the housing. The insulation assembly includes a heat absorbent material enclosed by a plastic cover. The heat absorbent material has a non-flammable liquid stored therein. The plastic cover is configured to shrink when a temperature of the plastic cover is above a threshold temperature, thereby releasing the non-flammable liquid from the heat absorbent material into the chamber to reduce a flow of heat from outside of the housing to the electrode assembly.

In addition to one or more of the features described herein, the at least one side includes a first wall and a second wall opposite the first wall with the battery cell disposed between the first wall and the second wall and the insulation assembly includes a first insulation apparatus disposed between the electrode assembly and the first wall and a second insulation apparatus disposed between the electrode assembly and the second wall.

In addition to one or more of the features described herein, the at least one side include a first wall and a second wall opposite the first wall with the battery cell disposed between the first wall and the second wall, wherein the insulation assembly includes an adhesive layer having a first section having a first insulation apparatus and a second section having a second insulation apparatus, wherein the adhesive layer adheres to the electrode assembly to dispose the first insulation apparatus between the first wall and the electrode assembly and the second insulation apparatus between the battery cell and the second wall.

In addition to one or more of the features described herein, the adhesive layer includes a third section between the first section and the second section, the third section adhering to a bottom of the electrode assembly.

In addition to one or more of the features described herein, the heat absorbent material is made of metal hydroxide and the non-flammable liquid is an organic solvent.

In addition to one or more of the features described herein, the housing is in the form of a cylindrical tube, the electrode assembly is in the shape of a cylindrical electrode and disposed within the cylindrical tube, and the insulation assembly is disposed between the cylindrical tube and the cylindrical electrode.

In addition to one or more of the features described herein, the housing includes a pouch film wrapped around the electrode assembly with the insulation assembly between the electrode assembly and the pouch film.

In another exemplary embodiment, an electrical system is disclosed. The electrical system includes a battery pack having a battery cell. The battery cell includes a housing having at least one side and forming a chamber, an electrode assembly disposed within the chamber, and an insulation assembly disposed in the chamber between the electrode assembly and the at least one side of the housing. The insulation assembly includes a heat absorbent material enclosed by a plastic cover. The heat absorbent material has a non-flammable liquid stored therein. The plastic cover is configured to shrink when a temperature of the plastic cover is above a threshold temperature, thereby releasing the non-flammable liquid from the heat absorbent material into the chamber to reduce a flow of heat from outside of the housing to the electrode assembly.

In addition to one or more of the features described herein, the at least one side includes a first wall and a second wall opposite the first wall with the battery cell disposed between the first wall and the second wall and the insulation assembly includes a first insulation apparatus disposed between the electrode assembly and the first wall and a second insulation apparatus disposed between the electrode assembly and the second wall.

In addition to one or more of the features described herein, the at least one side includes a first wall and a second wall opposite the first wall with the battery cell disposed between the first wall and the second wall, wherein the insulation assembly includes an adhesive layer having a first section having a first insulation apparatus and a second section having a second insulation apparatus, wherein the adhesive layer adheres to the electrode assembly to dispose the first insulation apparatus between the first wall and the electrode assembly and the second insulation apparatus between the battery cell and the second wall.

In addition to one or more of the features described herein, the adhesive layer includes a third section between the first section and the second section, the third section adhering to a bottom of the electrode assembly.

In addition to one or more of the features described herein, the heat absorbent material is made of metal hydroxide and the non-flammable liquid is an organic solvent.

In addition to one or more of the features described herein, the electrical system is one of an energy storage system, an electric vehicle, a component of a vehicle, a locomotive, and a marine vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in accordance with an exemplary embodiment;

FIG. 2 is a disassembled view of a battery cell of a battery pack in an illustrative embodiment;

FIG. 3 is a detailed view of the insulation apparatus, in an embodiment;

FIG. 4 is a view of the battery cell in an assembled state, in an illustrative embodiment;

FIG. 5 shows an insulation assembly in an embodiment;

FIG. 6 shows another insulation assembly in an embodiment;

FIG. 7 shows a battery cell that includes the insulation assembly of FIG. 6 disposed in a battery cell;

FIG. 8 is a battery cell in another embodiment;

FIG. 9 shows a top view of the battery cell of FIG. 8 at a cross-section of the battery cell, with an insulation assembly; and

FIG. 10 shows a pouch battery in a perspective view.

### DETAILED DESCRIPTION

The following description is merely exemplary in nature and is not intended to limit the present disclosure, its application or uses. It should be understood that throughout the drawings, corresponding reference numerals indicate like or corresponding parts and features.

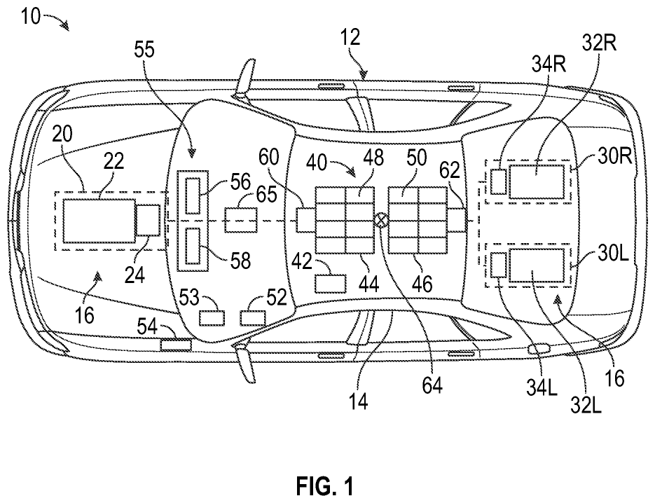

In accordance with an exemplary embodiment, FIG. 1 shows a vehicle 10. The vehicle 10 includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes a left rear electric motor 32L and a left rear inverter 34L. A right rear drive unit 30R includes a right rear electric motor 32R and a right rear inverter 34R. The front inverter 24, left rear inverter 34L and right rear inverter 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 the left rear electric motor 32L and the right rear electric motor 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives the front wheels (not shown), and the left rear electric motor 32L and right rear electric motor 32R drive the rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the front inverter 24, and a second battery pack 46. The first battery pack 44 includes a plurality of battery modules 48, and the second battery pack 46 includes a plurality of battery modules 50. Each battery module 48, 50 includes a number of individual battery cells (not shown). In various embodiments, one or more of the battery packs can include a MODACS (Multiple Output Dynamically Adjustable Capacity) battery.

Each of the front electric motor 22 and the left rear electric motor 32L and right rear electric motor 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the first battery pack 44 and second battery pack 46, and selectively connecting the first battery pack 44 and second battery pack 46 to the front drive unit 20, left rear drive unit 30L and right rear drive unit 30R. The switching devices may also be operated to selectively connect the first battery pack 44 and the second battery pack 46 to a charging system. The charging system can be used to charge the first battery pack 44 and the second battery pack 46, and/or to supply power from the first battery pack 44 and/or the second battery pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC).

In an embodiment, the switching system includes a first switching device 60 that selectively connects to the first battery pack 44 to the front inverter 24, left rear inverter 34L and right rear inverter 34R, and a second switching device 62 that selectively connects the second battery pack 46 to the front inverter 24, left rear inverter 34L and right rear inverter 34R. The switching system also includes a third switching device 64 (also referred to as a “battery switching device”) for selectively connecting the first battery pack 44 to the second battery pack 46 in series.

Any of various controllers can be used to control functions of the battery system 40, the switching system and the drive units. A controller includes any suitable processing device or unit and may use an existing controller such as a drive system controller, an RESS controller, and/or controllers in the drive system. For example, a controller 65 may be included for controlling switching and drive control operations as discussed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

As illustrated herein, the vehicle 10 is an electric vehicle. In alternative embodiments, the vehicle 10 can be an internal combustion engine vehicle, a hybrid vehicle, etc.

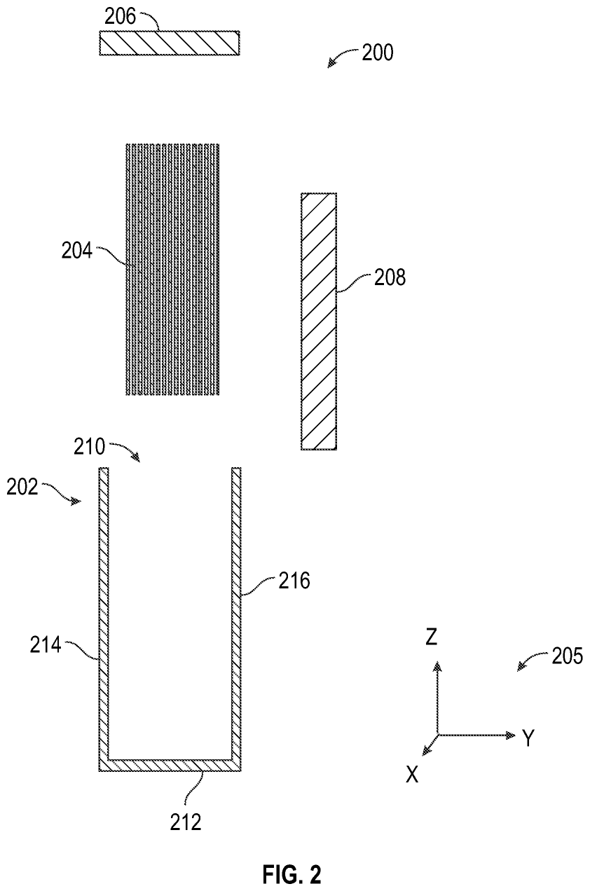

FIG. 2 is a disassembled view 200 of a battery cell of a battery pack in an illustrative embodiment. The battery cell includes a housing 202, an electrode assembly 204, a cap 206 and an insulation apparatus 208. A coordinate system 205 is shown for illustrative purposes only. The housing 202 can take the form of a canister or a box with an opening 210 at one end. The housing 202 includes a base 212 and at least one side wall and the opening 210 opposite the base. The base 212 is a four-edged surface that lies in an xy-plane of the coordinate system 205. In an embodiment, the at least one side wall includes four walls which extend from the base 212 along a z-axis of the coordinate system 205. For illustrative purposes, two opposing walls of the housing 202 are shown, referred to herein as a first wall 214 and a second wall 216. The electrode assembly 204 includes an anode, a cathode, and a separator material between the anode and the cathode. The separator material, the anode and the cathode can include voids and an electrolyte material can fill the voids of one or more of the separator material, the cathode and the anode.

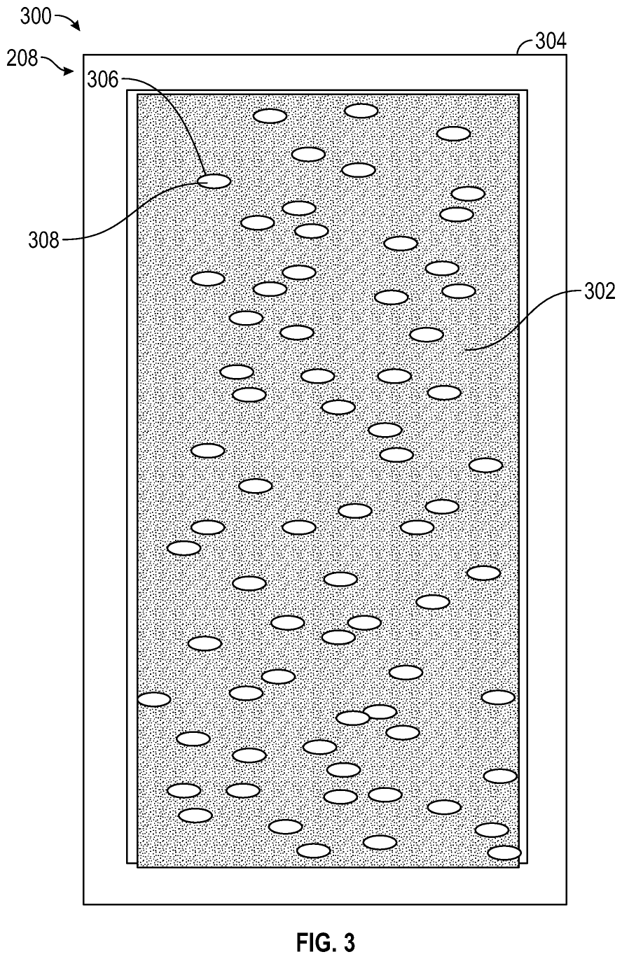

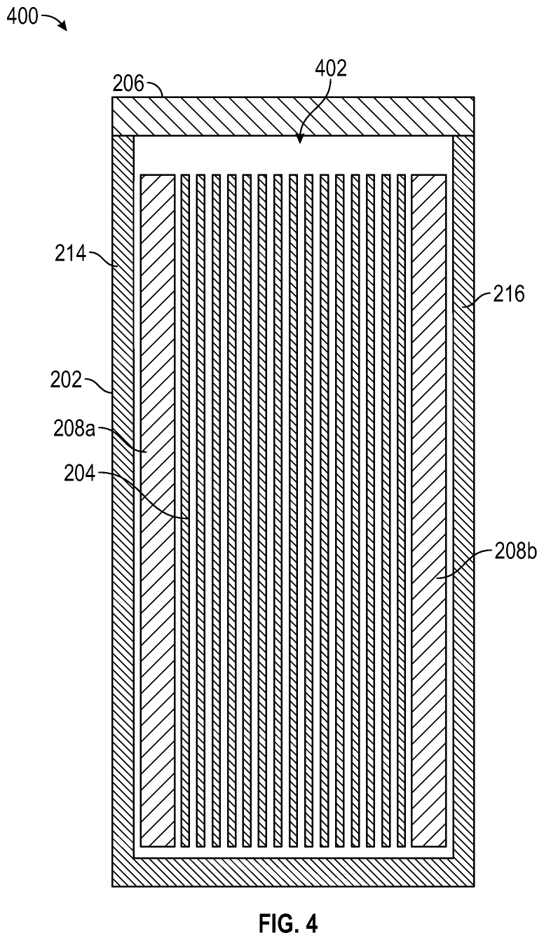

FIG. 3 is a detailed view 300 of the insulation apparatus 208, in an embodiment. The insulation apparatus 208 includes a heat absorbent material 302 enclosed in a plastic cover 304. The plastic cover 304 is made of a polyolefin, such as polyethylene or polypropylene. The heat absorbent material 302 is made of a compressed powder and includes a plurality of voids 306, the voids storing a non-flammable liquid 308, therein. In various embodiments, the non-flammable liquid 308 is an organic solvent (i.e., a non-flammable organic solvent). Exemplary non-flammable organic solvents include trimethyl phosphate (TMP), triethyl phosphate (TEP), tripropyl phosphate (TPrP), etc. In various embodiments, the heat absorbent material 302 is a metal hydroxide. Exemplary metal hydroxides include aluminum hydroxide, magnesium hydroxide, etc. The plastic cover 304 prevents the non-flammable liquid 308 from flowing out of the voids 306 and out of the heat absorbent material 302. When a temperature of the insulation apparatus 208 rises above a threshold temperature (e.g., above 120 degrees Celsius), the plastic cover 304 melts away or shrinks, thereby releasing the non-flammable liquid 308 from the voids 306 and into a chamber 402 (FIG. 4) to mix with the electrolyte fluid of the electrode assembly 204. The voids 306 of the heat absorbent material 302 are then filled with air. The resistance to heat flow of the heat absorbent material with the air-filled voids is greater than the resistance when the voids are filled with the non-flammable liquid 308. Thus, the heat absorbent material 302 (with air-filled voids) inhibits the flow of heat from outside the housing to the electrode assembly 204. At the electrode assembly 204, the non-flammable liquid 308 prevents a possible ignition of the elements of the electrode assembly, (i.e., the anode, the cathode, and the separator).

FIG. 4 is a view 400 of the battery cell in an assembled state, in an illustrative embodiment. The electrode assembly 204 and the insulation apparatus 208 are placed into the housing 202 via the opening 210. The cap 206 is then placed on the housing 202 at the opening 210 to form a chamber 402 that includes the electrode assembly 204 and the insulation apparatus 208. The electrode assembly 204 is disposed in the chamber 402 between the first wall 214 and the second wall 216. The insulation apparatus 208 is disposed between the electrode assembly 204 and the walls of the housing 202. In an embodiment, the insulation apparatus 208 includes a first insulation apparatus 208a disposed between a first side of the electrode assembly 204 and the first wall 214 and a second insulation apparatus 208b disposed between a second side of the electrode assembly and the second wall 216.

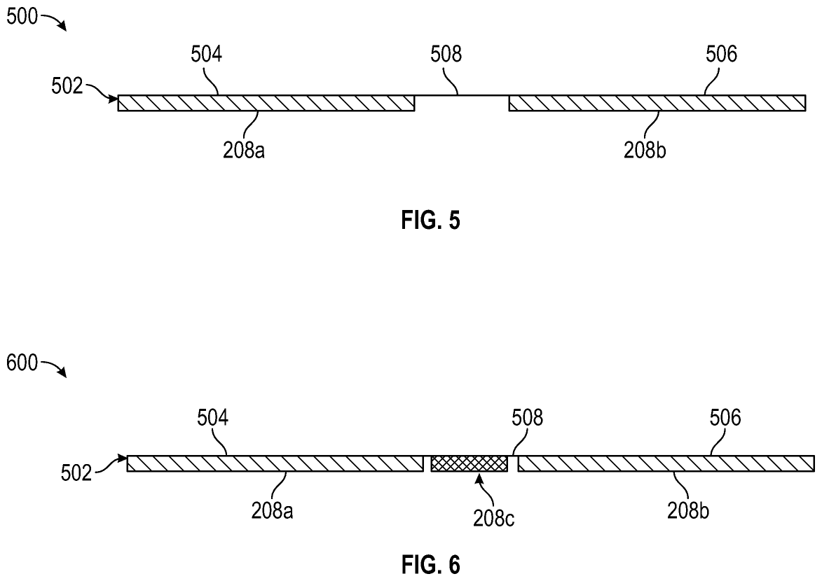

FIG. 5 shows an insulation assembly 500 in an embodiment. The insulation assembly 500 includes an adhesive layer 502 (e.g., a flexible tape) that is used to wrap around and adhere to the electrode assembly 204. The adhesive layer 502 has a first section 504, a second section 506 and a third section 508 between the first section and the second section. The first section 504 configured to adhere to a first side of the electrode assembly (e.g., proximate the first wall 214). The second section 506 is configured to adhere to a second side of the electrode assembly (e.g., proximate the second wall 216). The third section 508 is configured to adhere to a bottom of the electrode assembly (e.g., near base 212). The first section 504 includes the first insulation apparatus 208a and the second section 506 includes the second insulation apparatus 208b. Adherence of the adhesive layer 502 to the electrode assembly results in the battery cell configuration shown in FIG. 4.

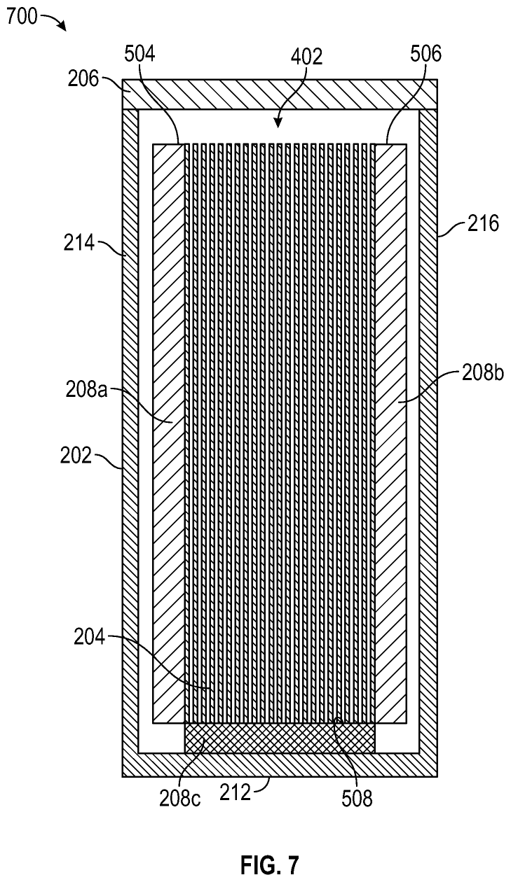

FIG. 6 shows another insulation assembly 600 in an embodiment. The insulation assembly 600 includes the adhesive layer 502 with the first section 504, the second section 506 and the third section 508. The first section 504 includes the first insulation apparatus 208a and the second section 506 includes the second insulation apparatus 208b. The third section 508 includes a third insulation apparatus 208c. The heat absorbent material of the third insulation apparatus 208c can have properties that are the same as or different than properties of the heat absorbent material of the first insulation apparatus 208a and the second insulation apparatus 208b. In particular, the heat absorbent material of the third insulation apparatus 208c can be coarser and have a higher porosity than the heat absorbent material of the first insulation apparatus 208a and the second insulation apparatus 208b. Thus, the third insulation apparatus 208c can be more flexible than the first insulation apparatus 208a and the second insulation apparatus 208b. The insulation assembly 600 can be disposed in the housing as shown in FIG. 7.

FIG. 7 shows a battery cell 700 that includes the insulation assembly 600 of FIG. 6 disposed in a battery cell. The first section 504 and first insulation assembly 208a are disposed between the electrode assembly 204 and the first wall 214. The second section 506 and second insulation assembly 208c are disposed between the electrode assembly 204 and the second wall 216. The third section 508 and the third insulation apparatus 208c are disposed between the electrode assembly 204 and the base 212.

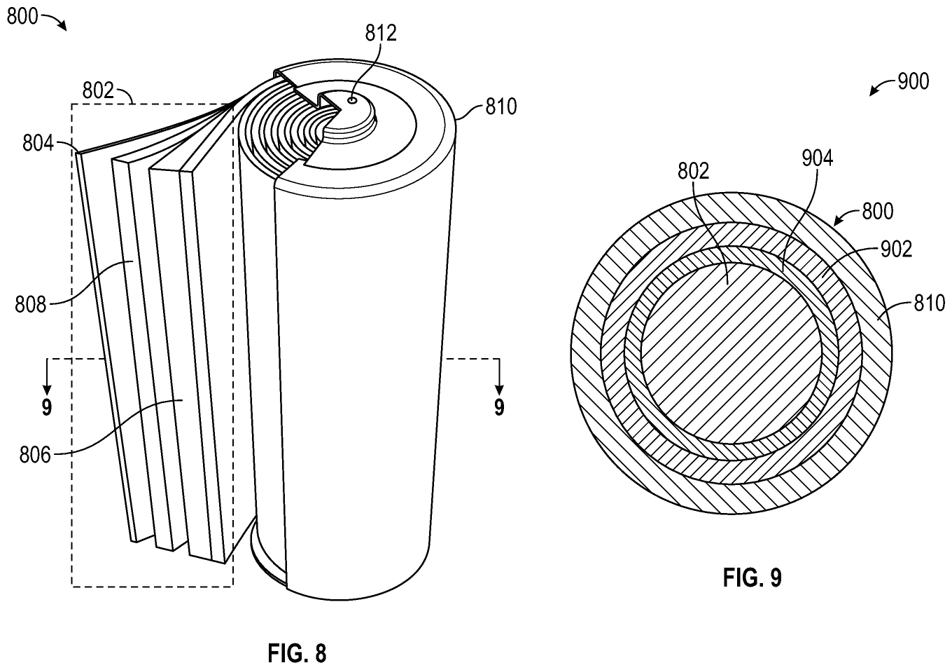

FIG. 8 is a battery cell 800 in another embodiment. The battery cell 800 includes an electrode assembly 802 having an anode layer 804, a cathode layer 806 and a separator layer 808 between the anode layer and the cathode layer. The anode layer 804, cathode layer 806 and separator layer 808 are made of flexible materials, which are rolled up to form a cylindrical electrode (or “jelly roll”). The jelly roll is disposed in a housing 810 that is in the form of a cylindrical tube. A cap 812 is placed at an end of the housing 810 to form a chamber that encloses the electrode assembly 802.

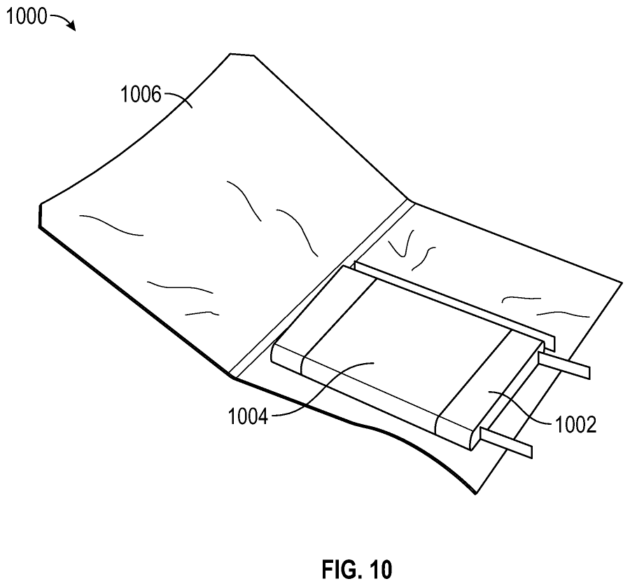

FIG. 9 shows a top view 900 of the battery cell 800 of FIG. 8 at cross-section 9-9, with an insulation assembly. The electrode assembly 802 is disposed within the housing 810. The insulation assembly includes an insulation apparatus 902 and an adhesive layer 904. The insulation assembly is wrapped around an outer surface of the cylindrical side of the electrode assembly 802. The adhesive layer 904 adheres the insulation apparatus 902 to the electrode assembly 802.

FIG. 10 shows a pouch battery 1000 in a perspective view. The pouch battery 1000 includes an electrode assembly 1002 and an insulation apparatus wrapped around the electrode assembly 1002. The electrode assembly 1002 and insulation assembly 1004 are disposed within a pouch film 1006. A pouch film 1006 is a flexible packaging material that serves as an outer casing or enclosure for the battery cell, providing mechanical support, electrical insulation, and protection against external elements. The pouch film 1006 can be made of multiple layers of materials. The innermost layer can be a polymer film that acts as a barrier to prevent the leakage of electrolyte and the penetration of moisture or contaminants. This innermost layer can be made of materials like polyethylene (PE), polypropylene (PP), or a combination of both. The outer layers of the pouch film provide structural integrity and protection. They can include materials like aluminum foil or other metalized films to enhance the barrier properties and provide additional protection against moisture and oxygen ingress.

The insulation assembly 1004 can include an insulation apparatus and adhesive, as disclosed herein. The pouch film 1006 is shown in an unwrapped state in FIG. 6. To form the pouch battery 1000, the pouch film 1006 is wrapped up to form a housing that encloses the electrode assembly 1002 and the insulation assembly 1004 therein.

The battery pack is described herein as being a component of an electric vehicle. In other embodiments, the battery pack can be a component of any type of electrical system, such as an energy storage system, a vehicle, a locomotive, a marine vehicle, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery cell, comprising:
a housing having at least one side and forming a chamber;
an electrode assembly disposed within the chamber; and
an insulation assembly disposed in the chamber between the electrode assembly and the at least one side of the housing, the insulation assembly including a heat absorbent material enclosed by a plastic cover, the heat absorbent material having a non-flammable liquid stored therein, wherein the plastic cover is configured to shrink when a temperature of the plastic cover is above a threshold temperature, thereby releasing the non-flammable liquid from the heat absorbent material into the chamber to reduce a flow of heat from outside of the housing to the electrode assembly.

2. The battery cell of claim 1, wherein the at least one side includes a first wall and a second wall opposite the first wall with the battery cell disposed between the first wall and the second wall and the insulation assembly includes a first insulation apparatus disposed between the electrode assembly and the first wall and a second insulation apparatus disposed between the electrode assembly and the second wall.

3. The battery cell of claim 1, wherein the at least one side includes a first wall and a second wall opposite the first wall with the battery cell disposed between the first wall and the second wall, and wherein the insulation assembly includes an adhesive layer having a first section having a first insulation apparatus and a second section having a second insulation apparatus wherein the adhesive layer adheres to the electrode assembly to dispose the first insulation apparatus between the first wall and the electrode assembly and the second insulation apparatus between the battery cell and the second wall.

4. The battery cell of claim 3, wherein the adhesive layer includes a third section between the first section and the second section, the third section adhering to a bottom of the electrode assembly.

5. The battery cell of claim 1, wherein the heat absorbent material is made of metal hydroxide and the non-flammable liquid is an organic solvent.

6. The battery cell of claim 1, wherein the housing is in the form of a cylindrical tube, the electrode assembly is in the shape of a cylindrical electrode and disposed within the cylindrical tube, and the insulation assembly is disposed between the cylindrical tube and the cylindrical electrode.

7. The battery cell of claim 1, wherein the housing includes a pouch film wrapped around the electrode assembly with the insulation assembly between the electrode assembly and the pouch film.

8. A battery pack for an electrical system, comprising:
a battery cell, comprising:
a housing having at least one side and forming a chamber;
an electrode assembly disposed within the chamber; and
an insulation assembly disposed in the chamber between the electrode assembly and the at least one side of the housing, the insulation assembly including a heat absorbent material enclosed by a plastic cover, the heat absorbent material having a non-flammable liquid stored therein, wherein the plastic cover is configured to shrink when a temperature of the plastic cover is above a threshold temperature, thereby releasing the non-flammable liquid from the heat absorbent material into the chamber to reduce a flow of heat from outside of the housing to the electrode assembly.

9. The battery pack of claim 8, wherein the at least one side includes a first wall and a second wall opposite the first wall with the battery cell disposed between the first wall and the second wall and the insulation assembly includes a first insulation apparatus disposed between the electrode assembly and the first wall and a second insulation apparatus disposed between the electrode assembly and the second wall.

10. The battery pack of claim 8, wherein the at least one side includes a first wall and a second wall opposite the first wall with the battery cell disposed between the first wall and the second wall, and wherein the insulation assembly includes an adhesive layer having a first section having a first insulation apparatus and a second section having a second insulation apparatus wherein the adhesive layer adheres to the electrode assembly to dispose the first insulation apparatus between the first wall and the electrode assembly and the second insulation apparatus between the battery cell and the second wall.

11. The battery pack of claim 10, wherein the adhesive layer includes a third section between the first section and the second section, the third section adhering to a bottom of the electrode assembly.

12. The battery pack of claim 8, wherein the heat absorbent material is made of metal hydroxide and the non-flammable liquid is an organic solvent.

13. The battery pack of claim 8, wherein the housing is in the form of a cylindrical tube, the electrode assembly is in the shape of a cylindrical electrode and disposed within the cylindrical tube, and the insulation assembly is disposed between the cylindrical tube and the cylindrical electrode.

14. The battery pack of claim 8, wherein the housing includes a pouch film wrapped around the electrode assembly with the insulation assembly between the electrode assembly and the pouch film.

15. An electrical system, comprising:
a battery pack having a battery cell, the battery cell comprising:
a housing having at least one side and forming a chamber;
an electrode assembly disposed within the chamber; and
an insulation assembly disposed in the chamber between the electrode assembly and the at least one side of the housing, the insulation assembly including a heat absorbent material enclosed by a plastic cover, the heat absorbent material having a non-flammable liquid stored therein, wherein the plastic cover is configured to shrink when a temperature of the plastic cover is above a threshold temperature, thereby releasing the non-flammable liquid from the heat absorbent material into the chamber to reduce a flow of heat from outside of the housing to the electrode assembly.

16. The electrical system of claim 15, wherein the at least one side includes a first wall and a second wall opposite the first wall with the battery cell disposed between the first wall and the second wall and the insulation assembly includes a first insulation apparatus disposed between the electrode assembly and the first wall and a second insulation apparatus disposed between the electrode assembly and the second wall.

17. The electrical system of claim 15, wherein the at least one side includes a first wall and a second wall opposite the first wall with the battery cell disposed between the first wall and the second wall, and wherein the insulation assembly includes an adhesive layer having a first section having a first insulation apparatus and a second section having a second insulation apparatus wherein the adhesive layer adheres to the electrode assembly to dispose the first insulation apparatus between the first wall and the electrode assembly and the second insulation apparatus between the battery cell and the second wall.

18. The electrical system of claim 17, wherein the adhesive layer includes a third section between the first section and the second section, the third section adhering to a bottom of the electrode assembly.

19. The electrical system of claim 15, wherein the heat absorbent material is made of metal hydroxide and the non-flammable liquid is an organic solvent.

20. The electrical system of claim 15, wherein the electrical system is one of: (i) an energy storage system; (ii) an electric vehicle; (iii) a component of a vehicle; (iv) a locomotive; and (v) a marine vehicle.
